(19) United States
(12) Patent Application Publication
(10) Pub. No.: US 2004/0230339 A1
(43) Pub. Date: Nov. 18, 2004

(54) Methods of managing based on measurements of actual use of product

(76) Inventors: Bryan Maser, Hugo, MN (US); Michael N. Shulman, Minneapolis, MN (US); Richard J. Mehus, Richfield, MN (US)

Correspondence Address: IPLM GROUP, P.A., POST OFFICE BOX 18455, MINNEAPOLIS, MN, 55418, US

(21) Appl. No.: 10/436,888

(22) Filed: May 12, 2003

(51) Int. Cl. G06F 17/00

(52) U.S. Cl. 700/240

(57) ABSTRACT

Methods of managing items associated with the dispensing of products used at a customer's location by measuring an amount of the product which is actually used at such customer location including accurately billing the customer for the product, managing a flat-fee billing account, tracking usage of the product or performing remote diagnostic and repair on the dispensing apparatus.

### TECHNICAL FIELD

This invention relates to methods of managing a dispensed product and, more particularly, to methods of managing a dispensed product whose use is measured at a customer's location.

### BACKGROUND

Dispensing systems to dispense an ingredient or product for a commercial purpose have been widely used in many industries. For example, in the restaurant industry, warewashing systems are employed to rapidly wash large quantities of eating utensils, plates, pots, pans, glassware, etc. In another example in the hotel industry, linens, towels, clothing and the like are washed in commercial cleaning systems. Such systems commonly employ dispensers to dispense chemicals, such as detergents, to effectively perform the washing function.

Methods have existed for delivering such ingredients or products to a customer's location for use in the cleaning apparatus. In one typical situation, a customer orders product from a seller or supplier that the customer expects to use in a succeeding timeframe, e.g., until the next delivery. Such a customer typically is billed by the seller or supplier for the product as it is shipped or delivered to the customer. In another situation, typically called a flat-fee arrangement, a customer contracts with a seller or supplier for all, or a portion, of a customer's needs for the product for a use period, such as a month. The seller or supplier then delivers an amount of the product to the customer to ensure that the customer will have enough product or ingredient on hand to satisfy the customer's needs during the use period.

Managing accounts of industrial users of such products is an important task. The industrial customer wants to have an adequate supply of such products on hand at all times to service the industrial customer's needs for the products. The manufacturer or distributors want to maintain inventories as low as possible while assuring an adequate supply of the product to the industrial customer. At the same time, the industrial customer does not want to pay for product that is not currently needed. Also at the same time, a distributor of the product wants to make sure that the distributor has enough product on hand to satisfy customer's demands. The manufacturer wants to have enough product on hand to ship to the distributor or to the customer and also wants to be able to plan production, secure raw material and minimize inventory.

Getting in the way of all of these wants is actually knowing how much of a product is actually being used by the customer. If the customer's supply of the product is not ideal (either too high or too low), the ramifications may be seen in product shortages (either at the customer, distributor or manufacturer, or any combination or all three).

### SUMMARY OF THE INVENTION

Dispensing an ingredient or product, usually from a container (either in a dispenser or self-contained) in order to accurately measure an amount of an ingredient or product dispensed, e.g., at a customer's location usually as the ingredient or product is used by the customer, provides significant advantages.

Accurately measuring the weight of a product being used at the customer's location can be advantageously utilized in a method to effectively bill the customer on the actual amount of the product used. Thus, the customer need not pay for a substantial of a product that is just sitting at the customer's location not ready to be used. Further, the manufacturer or distributor need not worry about the customer not ordering enough of the product to have enough on hand to prevent outages. The manufacturer or distributor can know accurately how much of a product is being used by the customer and tailor specific billing and invoicing plans for the customer.

In one embodiment, the present invention provides a method for a seller of billing a customer for product used at a second location. The product is provided from the seller at a first location to the customer at the second location. An amount of the product actually used by the customer is measured by weighing the product at the second location. The amount of the product actually used by the customer is communicated to the seller. The customer is billed based at least in part on the amount of the product communicated to the seller.

In a preferred embodiment, the product is weighed as the product is used by the customer.

In a preferred embodiment, the customer is billed by an amount determined by multiplying the amount of the product actually used by the customer by a price for the product per unit weight.

In a preferred embodiment, the second location is a customer location.

In a preferred embodiment, the first location is a billing location.

In a preferred embodiment, the billing location is centralized with respect to a plurality of customer locations.

In a preferred embodiment, the billing location is centralized with respect to a plurality of customers.

Accurately measuring the weight of a product used by a customer in a period of use can be advantageously utilized in a method to manage a flat-fee billing account. If usage of a product at a flat-fee account different substantially from the amount of product actually shipped to the customer, an anomaly exists. The customer may have legitimately needed to divert some of the product to another urgent need. The product may have spoiled or been wasted. Knowing the comparison between the amount of the product delivered and the amount of product used can alert the manufacturer or distributor to a problem or an opportunity to sell additional product.

In another embodiment, the present invention provides a method of managing an account for a customer in which the customer is billed a flat fee for amount of a product used by the customer in a period of use. The customer is billed the flat fee for the product used by the customer during the period of use. An amount of the product is delivered as requested by the customer for use during the period of use. An amount of the product actually used by the customer during the period of use is determined. The used amount is compared with the delivered amount. An action is taken as a result of the comparing step.

In a preferred embodiment, the determining step is accomplished by weighing the product.

In a preferred embodiment, the determining step is accomplished by weighing the product as the product is used by the customer.

In a preferred embodiment, the action comprises adjusting the flat fee based upon the delivered amount.

In a preferred embodiment, the action comprises notifying a sales person associated with the account.

In a preferred embodiment, the notifying step is accomplished automatically.

In a preferred embodiment, the action comprises adjusting a future delivery of the product so that the delivered amount more closely matches the amount.

Accurately measuring an amount of a product used by customer at one location can be advantageously utilized in a method which communicates the usage to another location enabling the customer's actual usage to be tracked. As an example, a manufacturer may utilize information about an amount of product being used by a customer as an “early warning system” to catch anomalies, or changes in usage patterns (either higher or lower) which wouldn't otherwise be visible to the manufacturer or distributor until much later when the customer started to vary orders for the product. Even then, the manufacturer or distributor might not suspect anything was different because the customer may just be adjusted inventory, either up or down. The manufacturer or distributor may use the actual usage information to plan for shipments and deliveries of product to the customer, plan manufacturing or other production schedules or even to affect promotions or promotional literature to selected ones or individual customers.

In another embodiment, the present invention provides a method of tracking, at a first location, a usage of a product used by customer at a second location. An amount of the product actually used by the customer at the second location is measured. The amount of the product used is communicated to the first location and tracked. An action is taken as a result of the tracking.

In a preferred embodiment, the action comprises planning a production schedule for manufacturing the product based upon the amount of the product actually used by the customer.

In a preferred embodiment, the action comprises targeting a promotional item based upon the amount of the product actually used by the customer.

In a preferred embodiment, the action comprises automatically notifying a sales agent for the product in the second location based upon the amount of the product actually used by the customer.

In a preferred embodiment, the measuring step is accomplished by weighing the product used by the customer.

In a preferred embodiment, the weighing the product is accomplished as the product is used by the customer.

In a preferred embodiment, the tracking step is accomplished with periodic usage reports.

In a preferred embodiment, the action comprises automatically delivering additional product to the customer at the second location.

Knowledge of a product being dispensed from a dispensing apparatus can be advantageously utilized in a method in which information about the product being dispensed is communicated to another location enabling remote diagnosis of the dispensing apparatus and remote modification of the dispensing apparatus. Since the manufacturer or distributor knows how much product has been shipped to a customer, or how much of a product is intended to be used per unit, e.g., time, cycle, process, etc., knowing how much product is actually used may point out a problem in the dispensing apparatus. Thus, the dispensing apparatus may be effectively remotely diagnosed and, under certain circumstances, may be remotely repaired or adjusted to accommodate for the difference.

In another embodiment, the present invention provides a method of maintaining, from a first location, a product dispensing apparatus at a second location. Information about the product dispensing apparatus is communicated from the second location to the first location. The product dispensing apparatus is diagnosed. The product dispensing apparatus is remotely modified from the first location based on the diagnosis.

In a preferred embodiment, the information communicated in the communicating step comprises a weight of the product dispensed and a time during which the product is dispensed.

In a preferred embodiment, the time is compared with the weight and an adjusted dispense time is determined based upon the comparison.

In a preferred embodiment, the remotely modifying step is accomplished by remotely adjusting the time during which the product is dispensed based upon the adjusted dispense time.

### BRIEF DESCRIPTION OF THE DRAWING

FIG. 1 is an illustration of a dispenser in which some or all of methods of the present invention may find usefulness;

FIG. 2 is a chart illustrating the weight of a dispensing ingredient of the dispenser of FIG. 1;

FIG. 3 is a flow chart illustrating an embodiment of the invention in which a product is dispensed by eroding the product with a diluent;

FIG. 4 is a flow chart illustrating an embodiment of the invention in which a customer is billed for a product based upon a measured amount of the product used at the customer's location;

FIG. 5 is a flow chart illustrating an embodiment of the invention managing the delivery of a product in a flat fee account;

FIG. 6 is a flow chart illustrating an embodiment of the invention which takes an action based upon a measured amount of a product used by a customer; and

FIG. 7 is a flow chart illustrating an embodiment of the invention which diagnoses a dispenser for a product based upon a remote monitoring of an amount of the product dispensed.

### DETAILED DESCRIPTION

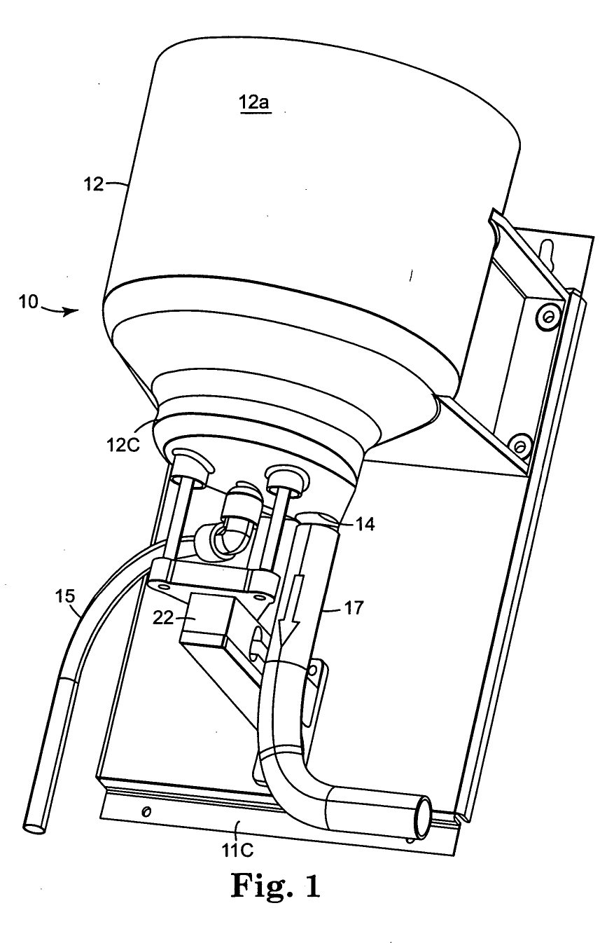

The methods of the present invention can be described, as an example, being used in conjunction with a mass based dispensing system such as a dispensing system described in co-pending U.S. patent application entitled “Method and Apparatus For Mass Based Dispensing,” by Richard Mehus et al., having a filing date even herewith and identified by attorney's docket number 117-P-1757US01, the content of which is hereby incorporated by reference. The dispenser described in such co-pending patent application is shown generally in FIG. 1. Dispenser 10 includes a housing 12 that has an outer wall 12a having a cavity (not shown). Outer wall 12a has a larger diameter at the top so as to accommodate capsule (not shown). The capsule, in a preferred embodiment, contains a solid block of an ingredient to be dispensed. Inlet hose 15 allows a diluent to be sprayed into capsule and onto the block of ingredient to be dispensed effectively eroding a portion of the block of ingredient. Sump region 12c provides for a collection that region for a use solution of the eroded ingredient and the diluent. Hose 17 is connected to outlet 14 allowing the use solution to be directed to a desired location. Load cell 22 measures that combined weight of capsule, the block of ingredient and any diluent contained in capsule.

Dispenser 10 operates by spraying a diluent through inlet host 15 into capsule and onto the block of ingredient. As the block of ingredient is eroded, a mixture of eroded ingredient and diluent is discharged from dispenser 10 through hose 17. Load cell 22 accurately measures the combined weight before the diluent is sprayed onto the block of ingredient, while the diluent is sprayed onto the block of ingredient and after the diluent is sprayed onto the block of ingredient.

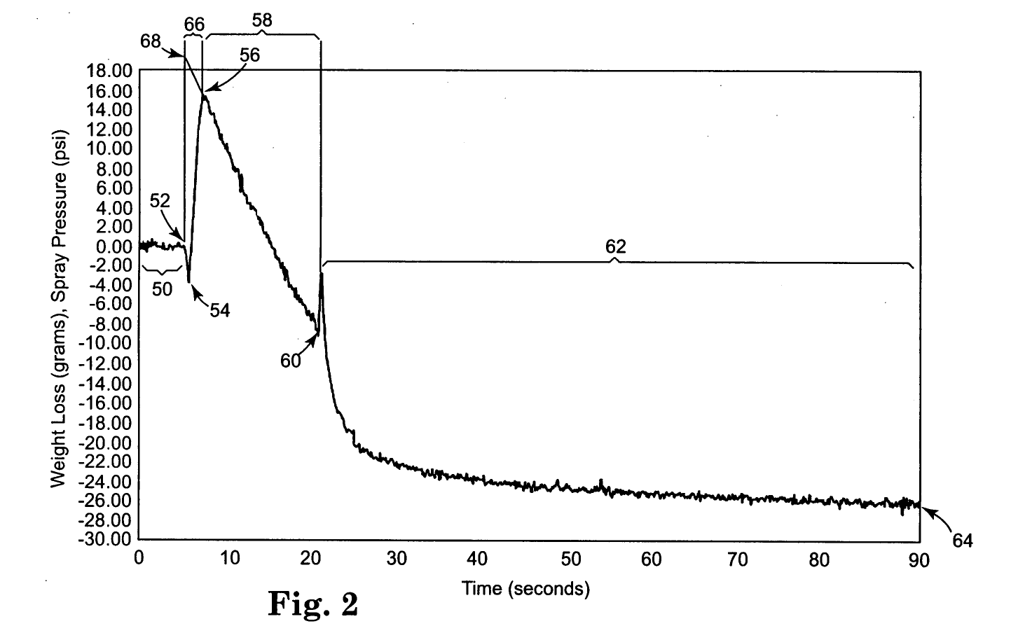

FIG. 2 is a chart illustrating the effect of the spray of diluent onto the block of ingredient in the dispenser of FIG. 1. The mantissa is time and the ordinate is weight in grams. Time 50 before the initiation of spray represents the starting combined weight, netted out at approximately zero (0) grams, for purposes of illustration. Spray is initiated at time 52 at which point two things begin to happen. First, pressure from the diluent sprayed on the underside of the block of ingredient relieves some of the combined weight from load cell 22. Second, the added weight from diluent accumulating in capsule tends to cause an increased combined weight. Thus, the combined weight on load cell 22 initially decreases until time 54 at which point the combined weight reaches an initial minimum of approximately minus four (−4) grams. Following time 54, the added weight of the diluent in capsule causes the combined weight to rather significantly increase. Over time, however, the added weight of the diluent in capsule tends to stabilize as the block of ingredient is eroded. As the block of ingredient is eroded, its weight decreases. Thus, at time 56 the combined weight reaches a maximum at approximately sixteen (16) grams. Following time 56 the block of ingredient continues to be eroded as the diluent continues to spray. Since the added weight of the diluent in capsule has stabilized, the combined weight continues to decrease during time 58 until the spray is discontinued. The spray of diluent is discontinued at time 60 causing a momentary weight gain for the combined weight as the upward pressure on the block of ingredient is discontinued. Following a momentary weight gain cause by the lack of upward pressure on the block of ingredient by the spray of diluent, diluent continues to drain from capsule during time period 62 resulting in the near final weight at time 64 of approximately minus twenty-six (−26) grams.

The difference between the starting weight at time 50 of approximately zero (0) grams and the ending weight of approximately minus twenty-six (−26) grams, once the diluent has drained from capsule, of twenty-six (26) grams represents the amount of ingredient dispensed. However, note that the difference between the maximum weight of approximately sixteen (16) grams and the weight at time 60 of approximately minus nine (−9) grams when spray is discontinued is only twenty-five (25) grams. This is because ingredient was eroded from the block of ingredient during time 66, between time 52 when spray is begun and time 56 when the maximum is measured, and also during time 62 as diluent drains from capsule.

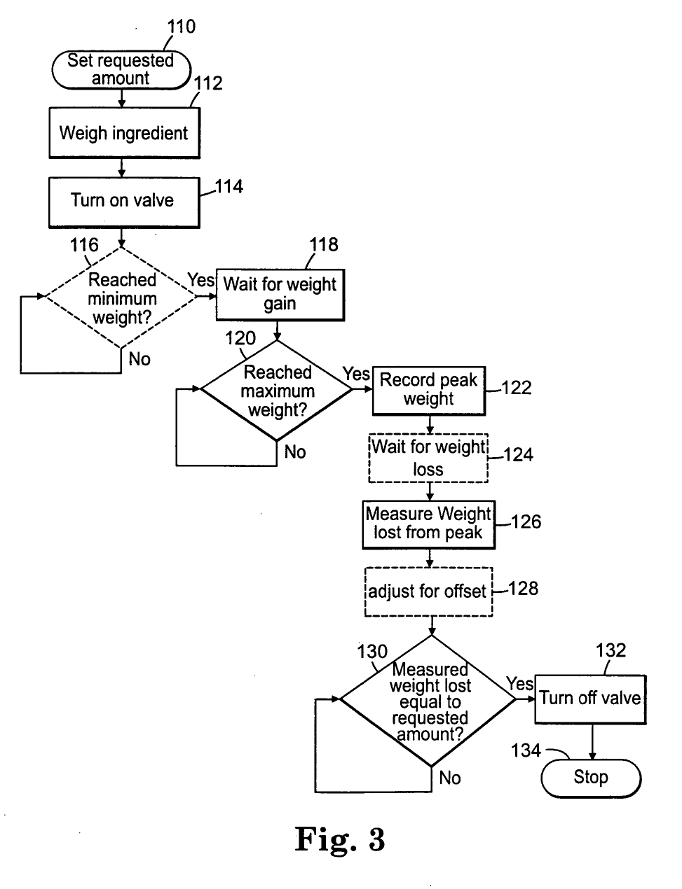

This process can be more readily understood with reference to the flow chart of FIG. 3. A requested amount of the ingredient requested is set (block 110). Load cell 22 weighs the ingredient (block 112). A valve is turned on (block 114) at time 52 initiating the spray of diluent against the block of ingredient. Optionally, the process waits (block 116) for a minimum weight at time 54 to be reached. The process waits (block 118) for diluent being added by spray to accumulate in capsule and increase the combined weight. Note that if the step represented by block 116 is omitted, it is still proper to wait for weight gain in block 118. Alternatively, if the step represented by block 116 is not omitted then it is no longer necessary to wait for weight gain and the step represented by block 118. Alternatively, the steps represented by both blocks 116 and 118 could be omitted in the process could continue directly to block 120. In block 120, the method searches for a maximum combined weight at time 56 and, once found, records that peak weight (block 122). Again optionally, the process waits for weight loss (block 124). Load cell 22 measures (block 126) the amount of weight lost from the maximum or peak weight recorded. Optionally, the process adjusts for an offset (block 128) which is explained below. The process determines (block 130) whether the measured weight lost is equal to an amount which will result in a dispensed amount of ingredient which equals the requested amount. When such a determination is made, the valve is turned off (block 132) discontinuing the spray of diluent against the block of ingredient. The process stops (block 134) until the process is repeated by again setting a requested amount (block 110).

Since some ingredient will be eroded from the block of ingredient during time 66 (between time 52 when spray is initiated and time 56 when weight loss begins to be recorded) and during time 62 (while remaining diluent drains from capsule), the amount of weight lost from capsule during time 58 does not necessarily equal the total weight of the ingredient eroded and, hence, dispensed. However, an amount of the ingredient which is additionally dispensed during time 66 and time 62 can be calculated and/or estimated by a variety of means. For example, this amount can be determined empirically from previous dispensed cycles. Alternatively, the slope of curve 48 during all or a portion of time 58 may be determined and an original maximum 68 may be determined by regression to account for an amount of the ingredient eroded during time 66. The amount of additional ingredient eroded during times 66 and 62 can be accounted for in the method in block 128 by adjusting the time 60 at which the spray of the diluent is discontinued. For example, if it is determined that the additional amount of the ingredient dispensed during time periods 66 and 62 is equal to approximately one (1) gram, then time 60 can be adjusted to turn off the spray of diluent when the measured weight loss is equal to the requested amount of ingredient minus one (1) gram.

A more detailed description of methods in which the present invention can be used is described in co-pending U.S. patent application entitled “Methods of Dispensing,” by Richard J. Mehus et al, having a filing date even herewith and identified by attorney's docket number 117-P-1758US01, the content of which is hereby incorporated by reference.

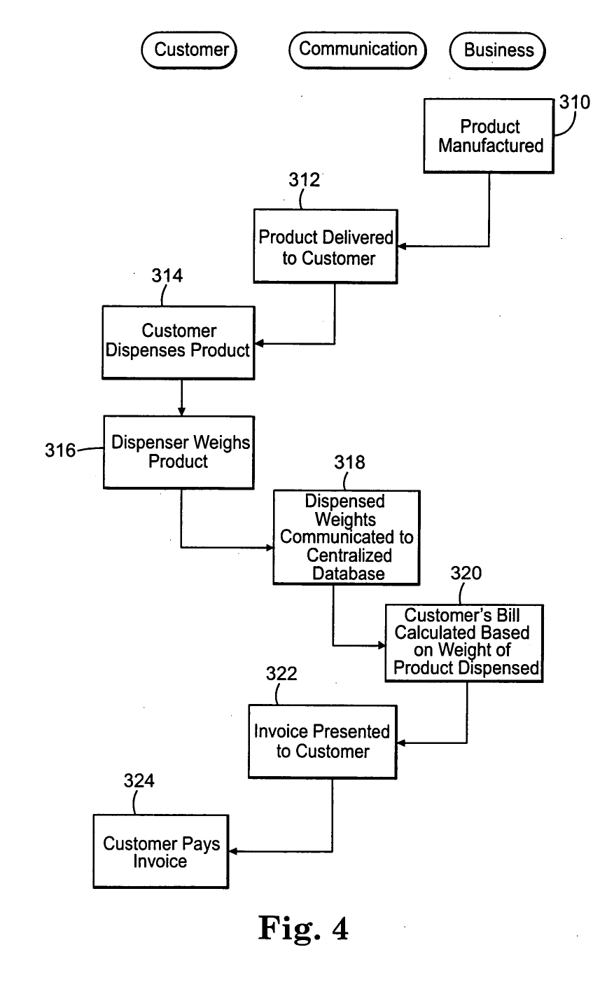

An embodiment of the present invention is illustrated in the flow chart of FIG. 4. A product is manufactured (block 310) or otherwise obtained and delivered (block 312) to a customer. The customer dispenses (block 314) the product and the dispenser weighs (block 316) the product to determine the amount dispensed. The dispensed amounts are then communicated (block 318) to a centralized or distributed database and the customer's bill is then based (block 320) on the actual amount of the product dispensed. Such a centralized database could be located, for example, at the manufacturer's or distributor's location. A distributed database could be field based and the bill could be calculated at the customer location. An invoice based on the calculated amount would then be presented (block 322) to the customer for payment and the customer pays (block 324) the invoice. Alternatively, automatic payment systems are also contemplated.

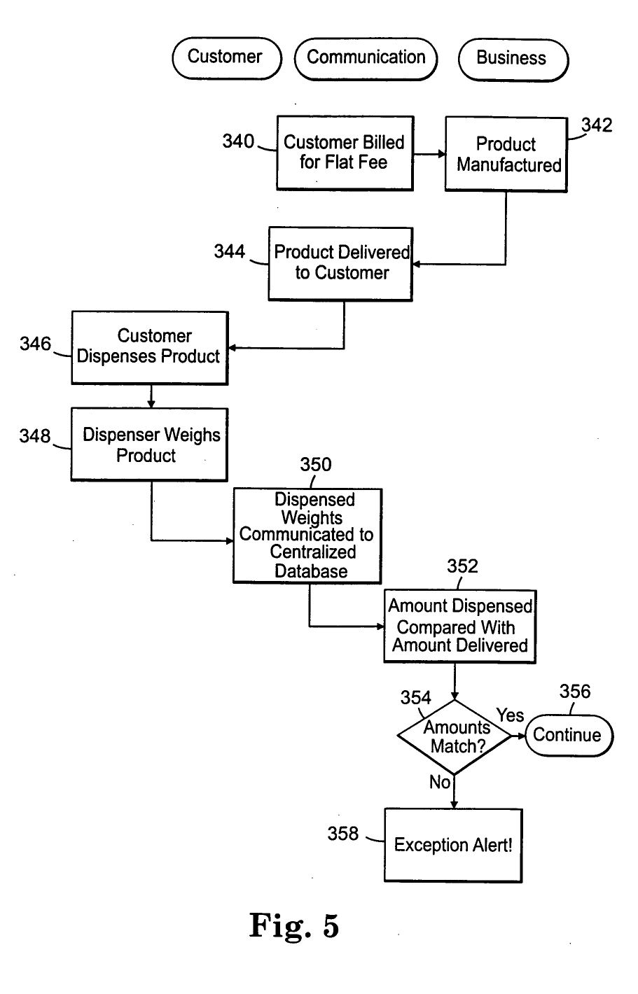

FIG. 5 is a flow chart illustrating another embodiment of the invention which manages a customer's flat-fee account. The customer is billed (block 340) a flat or otherwise periodic fee not directly tied to an amount of product used by the customer. Of course, to be effective the fee is intended to compensate for the amount of product used by the customer. As an example of this system, the customer would pay a fixed fee per period for all, or a portion, of the customer's needs of the product for that time period. The manufacturer or distributor would then ship to the customer enough of the product to satisfy the customer's needs during that period. While not directly tied to the amount of product used by the customer, the system will not work unless there's some coordination of the amount of product shipped with the amount paid for the product. In some cases involving such a flat-fee arrangement, some of the product intended to be used by the customer in a machine on which the flat-fee is based may be diverted to other uses. The result may be that the manufacturer or distributor could be shipping more product than the customer uses in the intended machine.

Once the fee is paid, or invoiced, or agreed-upon, the product is manufactured (block 342) or otherwise obtained and delivered (block 344) to the customer. The customer dispenses (block 346) the product and the dispenser weighs (block 348) the amount of product dispensed. The amount of product dispensed is communicated (block 350) to a centralized or distributed database. The amount dispensed can then be compared (block 352) with the amount of product delivered. If the amounts match (block 354), the process continues (block 356). If however, the amounts do not match, for example the delivered amount is greater than the dispensed amount, then an exception alert is generated (block 356) so that further action may be taken to analyze the situation. An example of an action which could be taken would be to notify, perhaps automatically, appropriate personnel to investigate the situation. One person who could be notified would be the sales person or area sales manager for the account.

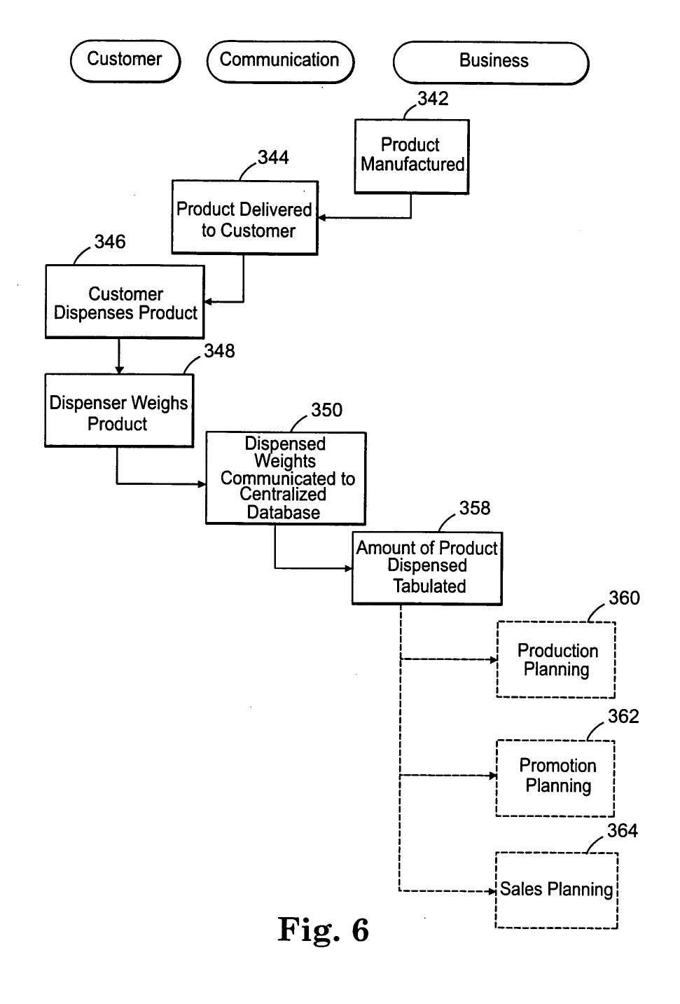

FIG. 6 is a flow chart illustrating another method utilizing the accurate determination of an amount of product dispensed or used by customer. Again the product is manufactured (block 342) or otherwise obtained and delivered (block 344) to the customer. The customer dispenses (block 346) the product and the dispenser weighs (block 348) the product dispensed to determine an amount dispensed. The amount of product dispensed is then communicated (block 350) to a centralized or distributed database. The amount of product dispensed may then be tracked, e.g., tabulated, (block 358) and subsequently utilized.

Examples of actions which can be taken as result of the tracking of use each of the product include production planning (block 360), promotion planning (block 362) and sales planning (block 364). Production planning (block 360) could include adjusting manufacturing processes and schedules in order to anticipate demand based on the amount of product being utilized, making more efficient use of inventory, and ensuring that the customer has an adequate supply of product by scheduling new deliveries commensurate with the customer's usage of the product. Promotion planning (block 362) could include planning promotions, including initiating promotions targeted directly at the customer whose usage is being measured, such as sales, specials, coupons and the like. Sales planning (block 364) could include ordering replacement product for the customer before the customer exhausts the supply of product on hand or the efficient scheduling of sales resources based on differing customer's usage of the product.

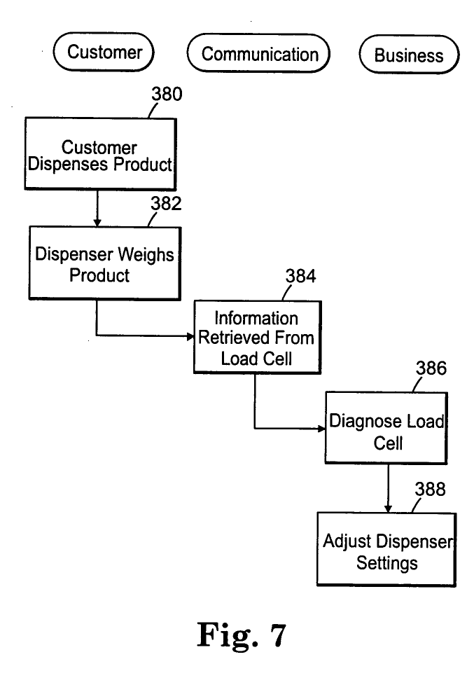

FIG. 7 is a flow chart illustrating an alternative embodiment of the present invention utilizing the accurate measurement of an amount of product dispensed in order to remotely diagnose and remotely adjust dispensing apparatus. The customer dispenses (block 380) the product and the dispenser weighs (block 382) the product dispensed in order to make an accurate measurement of the amount of product dispensed. Information relating to the amount of product dispensed may then be communicated, or retrieved, (block 384) from the dispenser, or load cell, and used to remotely diagnose (block 386) the dispensing apparatus. Once the diagnosis has, been made, settings on the dispenser may be adjusted (block 388) in order to correct, improve, or adjust the dispenser based on the diagnosis. As an example, if the dispenser is intended to dispense a predetermined amount of the product based upon dispensing for a predetermined period of time, communications indicating that the dispenser is consistently dispensing too much or too little of the product in the predetermined period of time could result in a remote adjustment of the period of time in which dispensing occurs.

Throughout this description various methods have made use of communication of information from one location to another location, for example, from a customer's location doing manufacturer's or distributor's location. Such information is variously involved information concerning amount of product dispensed or utilized by the customer and billing, invoicing, diagnosing or adjusting information, for example. It is recognized understood that this communication could occur through any of a wide variety of common communication techniques including, by way of example only, telephonic communication (both wired and wireless), data transmission (either by wire, dedicated or not, or wireless), internet or other online communication, electronic messaging, satellite communication networks, paging, and the like.

While the methods of this invention have been described throughout this description is dispensing an ingredient or product useful or utilized in an apparatus in the cleaning industry, for example a warewashing machine, it is to be recognized and understood that the methods of the present invention have usefulness in other applications as well.

The present invention has applicability in many areas in addition to those already discussed. The following is a list of at least some of the areas in which the invention may be used. In the area of pest elimination dispensing equipment, a load cell could be utilized to measure a pre-set amount of ready-to-use insecticide which would enable the user to document proof of delivery for regulatory compliance, while ensuring a consistent dose was used for each application. Use in the vehicle cleaning market could encompass the use of a chemical measurement device for a vehicle care product dispenser. The product could be in a solid, liquid or gel form. Delivery would be by conventional means such as a recirculating system for solid products or pump systems for liquids or gels. The load cell would measure precise weight changes in the product being delivered from a concentrate to create a ready-to-use solution or an intermediate solution that can be diluted at a user's convenience. The prior art procedures require chemical or volumemetric measurements by operators of product usage to ensure reproducible product delivery. As each product type varies greatly in chemical components for vehicle cleaning products, different chemical tests need to be developed and validated for each new product. Batch to batch variations in solid dissolution rates require very stringent quality control measures and greatly restrict new product development of solid systems. Large variations in product use temperature due to seasonal temperature variations in the vehicle cleaning market have negative effects on liquid product viscosities. Water pressure variations within vehicle cleaning sites result in wide changes in product delivery as many dilution systems are based on siphon technology. These variations often result in unacceptable differences in product delivery. All of the variations require human intervention to adjust the chemical delivery system. The use of the load cell technology would permit reproducible delivery of product regardless of chemical composition. This presents the possibilities of greater flexibility and product formulation. Concerns about variation in solid product solubility differences or liquid viscosity changes with temperature would be eliminated as only weight changes are measured. Simplicity of the dispenser design would also result as the same dispenser technology could be used for many product chemistries since chemical measurement systems do not need to be taken into account for each product.

Still another area where the present invention could be utilized is in the janitorial and health care areas. The janitorial business would be able to utilize the technology of the present invention for accurately dispensing two component chemistries as well as cross linking chemistries for floor care. For health care, the present invention would be able to be utilized for proof of delivery for sanitizers and disinfectants. There is also the need to deliver very accurate amounts of chemistry for instrument care and hard surface cleaning. The technology would be available for both liquid and solid products. The present invention is also applicable for Housekeeping. The invention is able to be utilized as a platform for accurate solid, liquid or concentrate proportioning when it is used in conjunction with a device that can quantify an amount of water passing through a pipe. For example, if a known volume of water is used, and the load cell could detect the amount of concentrate dispensed, a proportion would be known. So in an accurate dispenser of this kind, the user would set a proportion. While water is filling up the use vessel, the concentrate is dispensed. Dispensing the concentrate occurs until the proportion is satisfied. If a known amount of water is passed through a pipe in a fixed time, the dispenser could dispense the concentrate to satisfy the proportion. For example, if 100 milliliters of water is passed through the dispenser, a known amount of concentrate would be needed to satisfy the set proportion. The known amount of concentrate could be dispensed and stopped, when the load cell is satisfied.

The present invention is also applicable for laundry systems. Present laundry systems service two machines at a relatively high cost. The system is both complex and costly. The load cell technology of the present invention would reduce both the cost and complexity of a current laundry dispenser. Further, the current laundry system for liquid also has significant drawbacks in that there is no empty drum alarm and no way to compensate for the reduced output of the peristaltic pump dispensing. Load cell technology of the present invention would allow for accurate dispensing of the peristaltic pump over time, providing a signal of when to change the squeeze tube, and allow and empty warning device. These would be significant improvements over the prior art. The foregoing is not an exhaustive list but are just further examples of the applicability of the present invention.

Various modifications and alterations of this invention will be apparent to those skilled in the art without departing from the scope and spirit of this invention. It should be understood that this invention is not limited to the illustrative embodiments set forth above.

What is claimed is:

1. A method for a seller of billing a customer for a product used at a second location, comprising the steps of:
providing said product from said seller at a first location to said customer at said second location;
measuring an amount of said product actually used by said customer by weighing said product at said second location;
communicating said amount of said product to said seller; and
billing said customer based at least in part on said amount of product communicated to said seller.

2. A method as in claim 1 wherein said measuring step weighs said product as said product is used by said customer.

3. A method as in claim 1 wherein said billing step is accomplished by billing said customer an amount determined by multiplying said amount of said product actually used by said customer by a price for said product per unit weight.

4. A method as in claim 1 wherein said second location is a customer location.

5. A method as in claim 1 wherein said first location is a billing location.

6. A method as in claim 5 wherein said billing location is centralized with respect to a plurality of customer locations.

7. A method as in claim 6 wherein said billing location is centralized with respect to a plurality of customers.

8. A method for a seller at a first location of billing an industrial customer for a cleaning product used at a second location, comprising the steps of:
providing said cleaning product from said seller at said first location to said industrial customer at said second location;
measuring an amount of said cleaning product actually used by said industrial customer by weighing said cleaning product at said second location;
communicating said amount of said cleaning product to said seller; and
billing said customer based at least in part on said amount of cleaning product communicated to said seller.

9. A method of managing an account of a customer in which said customer is billed a flat fee for an amount of a product used by said customer in a period of use, comprising the steps of:
billing said customer said flat fee for said product used by said customer during said period of use;
delivering a delivered amount of said product as requested by said customer for use during said period of use;
determining a used amount of said product actually used by said customer during said period of use;
comparing said used amount with said delivered amount; and
taking an action as a result of said comparing step.

10. A method as in claim 9 wherein said determining step is accomplished by weighing said product.

11. A method as in claim 10 wherein said determining step is accomplished by weighing said product as said product is used by said customer.

12. A method as in claim 9 wherein said action comprises adjusting said flat fee based upon said delivered amount.

13. A method as in claim 9 wherein said action comprises notifying a sales person associated with said account.

14. A method as in claim 13 wherein said notifying step is accomplished automatically.

15. A method as in claim 9 wherein said action comprises adjusting a future delivery of said product so that said delivered amount more closely matches said amount.

16. A method of managing an account of an industrial customer in which said customer is billed a flat fee for an amount of a cleaning product used by said industrial customer in a period of use, comprising the steps of:
billing said industrial customer said flat fee for said cleaning product used by said industrial customer during said period of use;
delivering a delivered amount of said cleaning product as requested by said industrial customer for use during said period of use;
determining a used amount of said cleaning product actually used by said industrial customer during said period of use;
comparing said used amount with said delivered amount; and
taking an action as a result of said comparing step.

17. A method of tracking, at a first location, a usage of a product used by a customer at a second location, comprising the steps of:
measuring an amount of said product actually used by said customer at said second location;
communicating said amount of said product to said first location;
tracking said amount of said product used by said customer; and
taking an action as a result of said tracking step.

18. A method as in claim 17 wherein the action comprises planning a production schedule for manufacturing said product based upon said amount of said product actually used by said customer.

19. A method as in claim 17 wherein the action comprises targeting a promotional item based upon said amount of said product actually used by said customer.

20. A method as in claim 17 wherein the action comprises automatically notifying a sales agent for said product in said second location based upon said amount of said product actually used by said customer.

21. A method as in claim 17 wherein said measuring step is accomplished by weighing said product used by said customer.

22. A method as in claim 21 wherein said weighing said product is accomplished as said product is used by said customer.

23. A method as in claim 17 wherein said tracking step is accomplished with periodic usage reports.

24. A method as in claim 17 wherein said action comprises automatically delivering additional product to said customer at said second location.

25. A method of tracking, at a first location, a usage of a cleaning product used by an industrial customer at a second location, comprising the steps of:
measuring an amount of said cleaning product actually used by said industrial customer at said second location;
communicating said amount of said cleaning product to said first location;
tracking said amount of said cleaning product used by said industrial customer; and
taking an action as a result of said tracking step.

26. A method of maintaining, from a first location, a product dispensing apparatus at a second location, comprising the steps of:
communicating information about said product dispensing apparatus from said second location to said first location;
diagnosing said product dispensing apparatus; and
remotely modifying said product dispensing apparatus from said first location based upon said diagnosing step.

27. A method as in claim 26 wherein said information communicated in said communicating step comprises a weight of said product dispensed and a time during which said product is dispensed.

28. A method as in claim 27 wherein said diagnosing step comprises comparing said time with said weight and determining an adjusted dispense time based upon said comparing.

29. A method as in claim 28 wherein said remotely modifying step is accomplished by remotely adjusting said time during which said product is dispensed based upon said adjusted dispense time.

30. A method of maintaining, from a first location, a cleaning product dispensing apparatus at a second location, comprising the steps of:
communicating information about said cleaning product dispensing apparatus from said second location to said first location;
diagnosing said product dispensing apparatus; and
remotely modifying said cleaning product dispensing apparatus from said first location based upon said diagnosing step.
